(19) United States
(12) Patent Application Publication
(10) Pub. No.: US 2018/0033379 A1
(43) Pub. Date: Feb. 1, 2018

(54) METHOD AND APPARATUS FOR CONTROLLING LIQUID CRYSTAL DISPLAY, AND ELECTRONIC DEVICE

(71) Applicant: Beijing Xiaomi Mobile Software Co., Ltd., Beijing (CN)

(72) Inventors: Guosheng LI, Beijing (CN); Anyu LIU, Beijing (CN); Zhongsheng JIANG, Beijing (CN)

(21) Appl. No.: 15/663,825

(22) Filed: Jul. 31, 2017

(30) Foreign Application Priority Data
Jul. 29, 2016 (CN) 201610616784.X

(51) Int. Cl. G09G 3/34; G09G 3/20; G09G 3/36

(52) U.S. Cl. CPC G09G 3/3406; G09G 3/3648; G09G 3/2074; G09G 2320/062; G09G 2320/064; G09G 2320/08; G09G 2300/0452; G09G 2310/08

(57) ABSTRACT

A method and apparatus for controlling a liquid crystal display (LCD), and an electronic device are provided. The method for controlling the LCD includes: controlling a backlight circuit of the LCD to be in an unconnected state during effective data refreshing time of the ith display frame, wherein the effective data refreshing time is a time period during which the ith display frame is scanned line by line, and wherein i represents a positive integer; and controlling the backlight circuit of the LCD to be in a connected state during blanking time of the ith display frame, wherein the blanking time is a time period during which a current display frame is displayed constantly.

### CROSS-REFERENCE TO RELATED APPLICATION

This application claims priority to and benefits of Chinese Patent Application Serial No. 201610616784.X, filed with the State Intellectual Property Office of P. R. China on Jul. 29, 2016, the entire content of which is incorporated herein by reference.

### TECHNICAL FIELD

The present disclosure relates to the field of display technology, and more particularly, to a method and an apparatus for controlling a liquid crystal display, and an electronic device.

### BACKGROUND

Liquid crystal display (LCD) is a kind of display currently in wide use. An LCD may also be used in Virtual Reality (VR) technology.

Typically, an LCD refreshes a display frame according to a predetermined frame rate (for example, 60 frames/second), the single frame display time of each display frame is about 16.7 milliseconds. The single frame display time may be divided into effective data refreshing time T1 and blanking time T2. During the effective data refreshing time T1, a display driver integrated circuit (DDIC) refreshes from the left top line to the last line of the display screen downward line by line. During the blanking time T2, the current display frame is displayed constantly, while a preparation for the refreshment of the next display frame is made. The liquid crystal may be flipped during a refreshment process, this kind of flipping will cause serious dynamic blur.

### SUMMARY

According to a first aspect of embodiments of the present disclosure, a method for controlling a LCD is provided, and the method includes: controlling a backlight circuit of the LCD to be in an unconnected state during effective data refreshing time of an ith display frame, in which the effective data refreshing time is a time period during which the ith display frame is scanned line by line, and in which i represents a positive integer; and controlling the backlight circuit to be in a connected state during blanking time of the ith display frame, in which the blanking time is a time period during which a current display frame is displayed constantly.

According to a second aspect of embodiments of the present disclosure, an apparatus for controlling a LCD is provided, and the apparatus includes a processor; and a memory configured to store instructions executable by the processor; in which the processor is configured to: control a backlight circuit of the LCD to be in an unconnected state during effective data refreshing time of an ith display frame, wherein the effective data refreshing time is a time period during which the ith display frame is scanned line by line, and wherein i represents a positive integer; and control the backlight circuit to be in a connected state during blanking time of the ith display frame, wherein the blanking time is a time period during which a current display frame is displayed constantly.

According to a third aspect of embodiments of the present disclosure, an electronic device is provided, the electronic device includes a LCD and a DDIC, and the DDIC is configured to: control a backlight circuit of the LCD to be in an unconnected state during effective data refreshing time of an ith display frame, in which the effective data refreshing time is a time period during which the ith display frame is scanned line by line, and in which i represents a positive integer; and control the backlight circuit to be in a connected state during blanking time of the ith display frame, in which the blanking time is a time period during which a current display frame is displayed constantly.

It should be appreciated that the general description above and the following detailed description are just exemplary, thus should not be seen as any restriction to the present disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a schematic diagram illustrating a structure of a LCD panel according to parts of the example embodiments.

FIG. 2 is a schematic diagram illustrating a structure of a liquid crystal driver circuit according to parts of the example embodiments.

FIG. 3 is a flow chart showing a method for controlling a LCD according to an example embodiment.

FIG. 4 is a flow chart showing a method for controlling a LCD according to another example embodiment.

FIG. 5 is a schematic diagram showing a kind of partition of single frame display time according to an example embodiment.

FIG. 6 is a schematic diagram showing a wave pattern of a pause-width modulation signal according to an example embodiment.

FIG. 7 is a flow chart showing a method for controlling a LCD according to another example embodiment.

FIG. 8A is a flow chart showing sub-steps of block 701 according to an example embodiment.

FIG. 8B is a schematic diagram showing a refreshment of display data according to an example embodiment.

FIG. 9 is a block diagram showing an apparatus for controlling a LCD according to an example embodiment.

FIG. 10 is a block diagram showing an apparatus for controlling a LCD according to another example embodiment.

FIG. 11 is a block diagram showing an electronic device according to an example embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

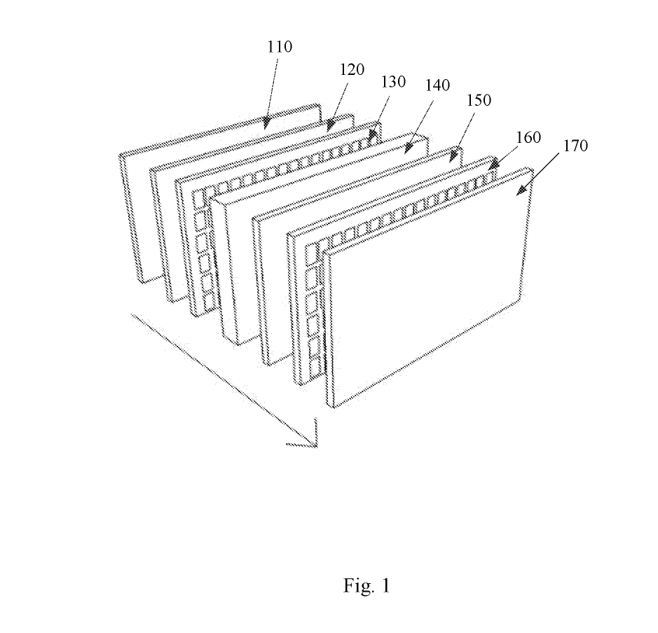

Before the illustration and description of embodiments of the present disclosure, a basic illustration about an LCD panel is provided first with reference to FIG. 1, which shows a structure of an LCD panel.

As shown in FIG. 1, the LCD panel includes a backlight circuit 110, a lower polarizer 120, an array substrate 130, a liquid crystal layer 140, an upper substrate 150, a color filter layer 160 and an upper polarizer 170.

The lower polarizer 120 is located on top of the backlight circuit 110, the array substrate 130 is located on top of the lower polarizer 120, liquid crystal layer 140 is located on top of the array substrate 130, the upper substrate 150 is located on top of the liquid crystal layer 140, the color filter layer 160 is located on top of the upper substrate 150, the upper polarizer 170 is located on top of the color filter layer 160.

The backlight circuit 110 is adaptive for providing backlight for an LCD panel, the backlight circuit 110 could be, but not limited to, any of the following kinds: electro luminescent (EL), cold cathode fluorescent lamp (CCFL), light emitting diode (LDE) and etc..

The lower polarizer 120 and the upper polarizer 170 are adaptive for transmission of a light ray in certain directions, and the transmission axis of the lower polarizer 120 and transmission axis of the upper polarizer 170 are perpendicular to each other.

In some embodiments, the array substrate 130 includes m*n pixel units, each pixel unit includes K sub pixel units, usually, each pixel unit includes 3 sub pixel units, which are a red (R) sub pixel unit, a green (G) sub pixel unit, and a blue (B) sub pixel unit. In some embodiments, each pixel unit includes 4 sub pixel units, which are an R sub pixel unit, a G sub pixel unit, a B sub pixel unit, and a white (W) sub pixel unit. That is, the value of K may be 3 or 4.

The liquid crystal molecules in the liquid crystal layer 140 may rotate under the control of a thin film transistor (TFT) area of the array substrate 130, with different rotate angles corresponding to different transmittance of light, thus forming the display gray scale of each pixel unit.

The color filter layer 160 is stuck to the up-surface of the upper substrate 150, the color filter layer 160 makes it possible for the LCD panel to present a colorful picture, color filter layer 160 includes R, B three different colors (red, green, blue) of light filtering areas arranged in array. There is a one to one correspondence between the light filtering areas and the sub pixel units on the array substrate 130.

The light generated by the backlight circuit 110 may go through the lower polarizer 120, the array substrate 130, the liquid crystal layer 140, the upper substrate 150, the color filter layer 160 and the upper polarizer 170 in an order from bottom to top, the rotation direction of the liquid crystal molecules in the liquid crystal layer 140 may be controlled by the voltage provided by the array substrate 130, the luminance of the light may be changed according to the rotation direction of the liquid crystal molecules in the liquid crystal layer 140 thereby the sub pixel units corresponding to the different colors R, B in the color filter layer may come into different gray scales, thus realizing the display of data.

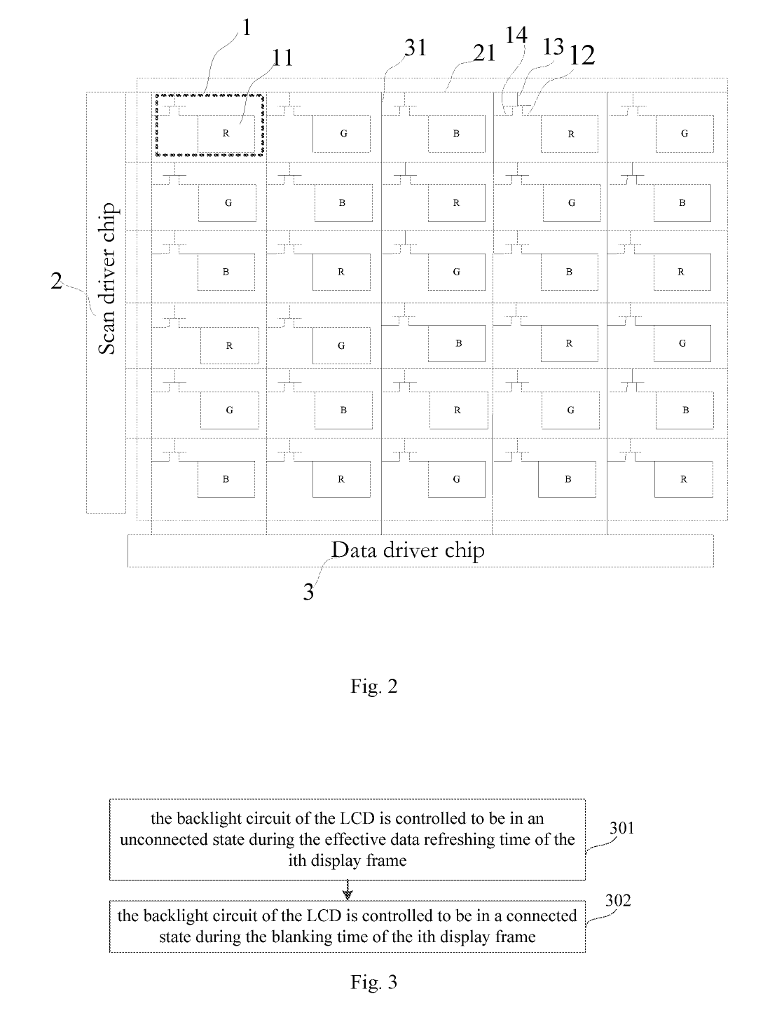

FIG. 2 is a schematic diagram illustrating a structure of a liquid crystal driver circuit. As shown in FIG. 2, the liquid crystal driver circuit includes a DDIC, m*n crystal units 1, m scan lines 21 and n data lines 31, in which, the DDIC includes scan driver chip 2 and data driver chip 3.

The liquid crystal units 1 are arranged in an array of m rows and n columns. Each liquid crystal unit 1 includes a sub pixel electrode 11 and a TFT switch element. A TFT switch element includes a source electrode 12, a grid electrode 13 and a drain electrode 14. A sub pixel electrode 11 is connected to a source electrode 12 of a TFT switch element. A sub pixel electrode 11 may be a red sub pixel electrode R, a green sub pixel electrode G or a blue sub pixel electrode B.

The scan driver chip 2 includes m scan pins and each scan pin is connected to a scan line 21. Each row of the liquid crystal units 1 corresponds to a scan line 21, and the scan line 21 is connected to the grid electrodes 13 of the liquid crystal units 1 in the corresponding row.

The data driver chip 3 includes n data pins and each data pin is connected to a data line 31. Each column of the liquid crystal units 1 corresponds to a data line 31, and the data line 31 is connected to the drain electrodes 14 of the liquid crystal units 1 in the corresponding column.

When the liquid crystal driver circuit operates, for a frame of data, the scan driver chip 2 sends scan signals to the scan lines 21 line by line from top to bottom, thus a scan line 21 which receives a scan signal could set the corresponding row of liquid crystal units 1 to an operation state. At the same time, the data driver chip 3 transmits a gray scale voltage of the pixel points corresponding to the line of the liquid crystal units 1 to the corresponding drain electrodes 14 through a data line 31, thus the data driver chip 3 may store the corresponding gray scale voltage into a sub pixel electrode 11, and make each and every sub pixel electrode 11 display the corresponding level of gray scale, thus realizing the display of a frame of data.

In the embodiments of the present disclosure, the single frame display time is divided into effective data refresh time and blanking time, the effective data refreshing time is the time period during which the ith display frame is scanned line by line, the blanking time is the time period during which the current display frame is displayed. During the effective data refreshing time of the ith display frame, the DDIC output a pause-width modulation signal to the backlight circuit of the LCD, the wave pattern of the pause-width modulation signal corresponding to the effective data refreshing time of the ith display frame is a first level signal, and the first level signal is used for controlling the backlight circuit of the LCD to be in an unconnected state, the backlight is not illumined. During the blanking time of the ith display frame, the DDIC output a pause-width modulation signal to the backlight circuit of the LCD, the wave pattern of the pause-width modulation signal corresponding to the blanking time of the ith display frame is a second level signal, and the second level signal is used for controlling the backlight circuit of the LCD to be in a connected state, the backlight is illumined.

It should be further noted that typically, single frame display time is divided into effective data refreshing time and blanking time, in which, the effective data refreshing time is relatively longer and blanking time is shorter. While in the embodiments of the present disclosure, in the same single frame display time, the effective data refreshing time is relatively shorter and blanking time is longer, thus the flipping time of the liquid crystal during a refreshment process is shorter, a serious dynamic blur caused by such flipping is avoided and the display performance of an LCD is optimized.

FIG. 3 is a flow chart showing a method for controlling a LCD according to an example embodiment. As shown in FIG. 3, the method for controlling the LCD includes the following actions.

In block 301, the backlight circuit of the LCD is controlled to be in an unconnected state during the effective data refreshing time of the ith display frame.

The effective data refreshing time is the time period during which the ith display frame is scanned line by line, in which i represents a positive integer. The backlight circuit in an unconnected state means the backlight is not illumined.

In block 302, the backlight circuit of the LCD is controlled to be in a connected state during the blanking time of the ith display frame.

The blanking time is the time period during which the current display frame is displayed constantly. The backlight circuit in a connected state means the backlight is illumined.

In summary, with the method for controlling a LCD provided in the embodiments of the present disclosure, by controlling the backlight circuit of the LCD to be in an unconnected state during the effective data refreshing time of the ith display frame, in which the effective data refreshing time is the time period during which the ith display frame is scanned line by line, in which i represents a positive integer, and by controlling the backlight circuit of the LCD to be in a connected state during the blanking time of the ith display frame. Thus, the liquid crystal flipping during a refreshment process and the serious dynamic blur caused by this kind of flipping may be avoided. During the effective data refreshing time, the backlight circuit is controlled to be in an unconnected state, i.e. the backlight is not illumined, thus making the flipping process of the liquid crystal invisible, a serious dynamic blur caused by liquid crystal flipping is avoided and the display performance of an LCD is optimized.

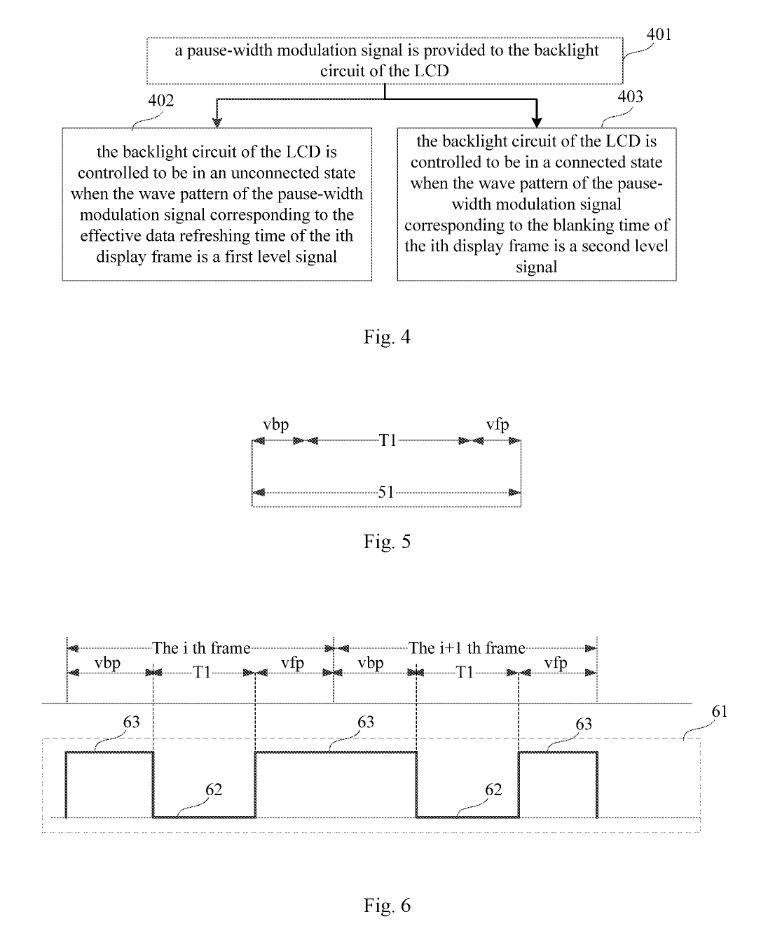

FIG. 4 is a flow chart showing a method for controlling a LCD according to another example embodiment. As shown in FIG. 4, the method for controlling the LCD includes the followings.

In block 401, a pause-width modulation signal is provided to the backlight circuit of the LCD.

The LCD refreshes the ith display frame according to a predetermined frame rate, for example, a predetermined frame rate of 60 frames/second, then the single frame display time of each display frame is about 16.7 milliseconds. In which, the single frame display time is divided into effective data refresh time and blanking time. For example, as shown in FIG. 5, the single frame display time 51 is 16.7 ms, in which, the effective data refreshing time T1 is 8 ms, the blanking time vbp and vfp before and after the effective data refreshing time T1 are 8.7/2=4.35 ms each. While in the related art, the effective data refreshing time T1 is 12 ms, the blanking time vbp and vfp before and after the effective data refreshing time T1 are 4.7/2=2.35 ms each.

During the effective data refreshing time of the ith display frame, DDIC refreshes the display data of the ith display frame from the first line at the left top corner downwardly line by line. DDIC outputs a corresponding pause-width modulation signal according to the refreshing position of the ith display frame in the LCD and transmits the output pause-width modulation signal to the backlight circuit of the LCD.

In some embodiments, the ith display frame includes at least one kind of the following: one display frame for displaying data, parts of the display frames for displaying data and all the display frames for displaying data, in which i represents a positive integer.

In block 402, the backlight circuit of the LCD is controlled to be in an unconnected state when the wave pattern of the pause-width modulation signal corresponding to the effective data refreshing time of the ith display frame is a first level signal.

The first level signal is configured to control the backlight circuit to be in an unconnected state. When the backlight circuit receives a pause-width modulation signal transmitted by the DDIC in which the wave pattern corresponding to the effective data refreshing time of the ith display frame is the first level signal, the voltage of the backlight circuit is in low level, the backlight circuit is in an unconnected state, the backlight is not illumined, thus making the flipping process of the liquid crystal invisible, a serious dynamic blur caused by liquid crystal flipping is avoided and the display performance of an LCD is optimized.

In some embodiments, the effective data refreshing time is the time period during which the ith display frame is scanned line by line.

In block 403, the backlight circuit of the LCD is controlled to be in a connected state when the wave pattern of the pause-width modulation signal corresponding to the blanking time of the ith display frame is a second level signal.

The second level signal is configured to control the backlight circuit to be in a connected state. When the backlight circuit receives a pause-width modulation signal transmitted by the DDIC in which the wave pattern corresponding to the blanking time of the ith display frame is the second level signal, the voltage of the backlight circuit is in high level, the backlight circuit is in a connected state, the backlight is illumined, so as to display the refreshed display data of the ith display frame and optimize the display performance of the LCD.

In some embodiments, the blanking time is the time period during which the current display frame is displayed. The level value corresponding to the first level signal is lower than a level value corresponding to the second level signal.

In an example embodiment, the pause-width modulation signal 61 output from the DDIC to the backlight circuit is shown in FIG. 6. The single frame display time of two display frames is illustrated, in which, the wave pattern corresponding to the effective data refreshing time T1 of the ith display frame is low level signal 62, the wave pattern corresponding to the blanking time vbp and vfp of the ith display frame is high level signal 63, the wave pattern corresponding to the effective data refreshing time T1 of the i+1 th display frame is low level signal 62, the wave pattern corresponding to the blanking time vbp and vfp of the i+1 th display frame is high level signal 63.

It should be understood that, in this embodiment, the first level signal being a low level signal and the second level signal being a high level signal are just used as an example for illustration, other ways of implementation are not limited to the embodiments of the present disclosure.

In summary, with the method for controlling a LCD provided in the embodiments of the present disclosure, by controlling the backlight circuit of the LCD to be in an unconnected state during the effective data refreshing time of the ith display frame, in which the effective data refreshing time is the time period during which the ith display frame is scanned line by line, in which i represents a positive integer, and by controlling the backlight circuit of the LCD to be in a connected state during the blanking time of the ith display frame. Thus, the liquid crystal flipping during a refreshment process and the serious dynamic blur caused by this kind of flipping may be avoided. During the effective data refreshing time, the backlight circuit is controlled to be in an unconnected state, i.e. the backlight is not illumined, thus making the flipping process of the liquid crystal invisible, a serious dynamic blur caused by liquid crystal flipping is avoided and the display performance of an LCD is optimized.

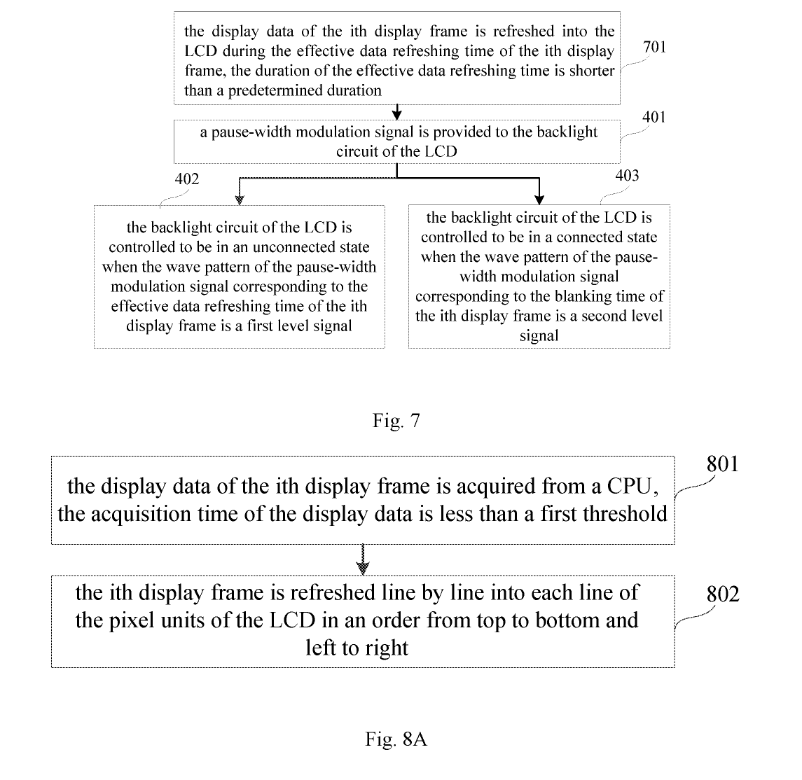

Based on the method for controlling a LCD shown in FIG. 4, as a potential way of implementation, the following action may also be included, which could be performed either in parallel with block 401 or before block 401, as shown in FIG. 7.

In block 701, the display data of the ith display frame is refreshed into the LCD during the effective data refreshing time of the ith display frame, the duration of the effective data refreshing time is shorter than a predetermined duration.

The effective data refreshing time is the time period during which the ith display frame is scanned line by line.

The LCD refreshes the ith display frame according to a predetermined frame rate, for example, a predetermined frame rate of 60 frames/second, then the single frame display time of each display frame is about 16.7 milliseconds. In which, the single frame display time is divided into effective data refresh time and blanking time, i represents a positive integer.

The display data of the ith display frame is refreshed into the LCD during the effective data refreshing time of the ith display frame, and the display data of the ith display frame is kept being displayed during the blanking time of the ith display frame. In some embodiments, the duration of the effective data refreshing time is shorter than a predetermined duration.

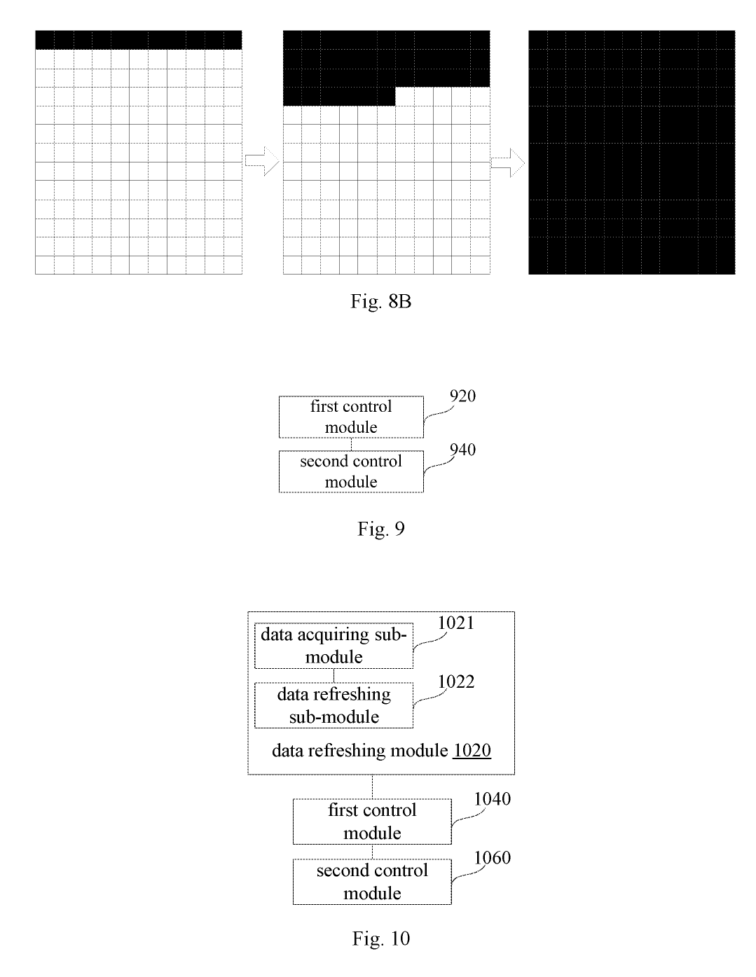

The present block may be substituted by the following sub steps, as shown in FIG. 8A.

In step 801, the display data of the ith display frame is acquired from a CPU, the acquisition time of acquiring the display data is less than a first threshold.

The DDIC could acquire display data of the ith display frame from the CPU through the following ways.

In some embodiments, the DDIC acquires display data of the ith display frame from the CPU during the effective data refreshing time of the ith display frame, so that the DDIC may refresh the acquired display data of the ith display frame.

In some embodiments, the acquisition time of acquiring by the DDIC the display data of the ith display frame from the CPU is less than a first threshold, for example, the acquisition time is 3 ms.

Alternatively, the DDIC acquires display data of the ith display frame from the CPU during the blanking time of the ith display frame, so that the DDIC may refresh the acquired display data of the ith display frame when entering the effective data refreshing time of the ith display frame. The blanking time during which the DDIC acquires the display data of the ith display frame is shown in FIG. 5 as the area corresponding to vbp.

The acquisition time of acquiring by the DDIC the display data of the ith display frame from the CPU is set to be less than a first threshold so that the duration of the effective data refreshing time of a display frame could be reduced and a serious dynamic blur caused by liquid crystal flipping could be avoided.

In step 802, the display data of the ith display frame is refreshed line by line into each line of the pixel units of the LCD in an order from top to bottom and left to right.

When the display data of the ith display frame is transmitted from the CPU to the DDIC, the display data of the ith display frame is refreshed line by line into each line of the pixel units of the LCD in an order from top to bottom and left to right. The specific process of a line by line refreshment is shown in FIG. 8B, FIG. 8 shows a line by line refreshment process of display data with 13 lines. The data is refreshed in an order from top to bottom and left to right, the left graph shows a schematic diagram showing that the DDIC starts to refresh the first line from the left top corner, the middle graph shows a schematic diagram showing that the DDIC refreshes to the middle of the fourth line from the left top corner in the order from top to bottom and left to right, the right graph shows a schematic diagram showing that the DDIC finishes refreshment of the whole 13th lines starting from the left top corner and in the order from top to bottom and left to right.

In some embodiments, the flipping response time of the liquid crystal in each and every pixel unit of the LCD is less than a second threshold.

The speed of flipping is a physical characteristic of liquid crystal, in order to make the flipping response time of the liquid crystal be less than a second threshold, usually the liquid crystal with a relatively higher flipping speed is chosen. The flipping response time of the liquid crystal in each and every pixel unit of the LCD is set to be less than a second threshold so that the duration of the effective data refreshing time of a display frame could be reduced and a serious dynamic blur caused by liquid crystal flipping could be avoided.

For example, when refreshing display data with 1000 lines, the flipping response time of the liquid crystal is 8 ms by using a kind of liquid crystal with a lower flipping speed, while by using a kind of liquid crystal with a higher flipping speed, the flipping response time of the liquid crystal is 5 ms.

The refreshing velocity of the display data of the ith display frame is inversely proportional to the flipping response time of the liquid crystal, when the flipping response time of the liquid crystal is less than the second threshold, the refreshing velocity of the display data of the ith display frame is faster than a predetermined velocity.

With the above means of setting the acquisition time of acquiring by the DDIC the display data of the ith display frame from the CPU to be less than a first threshold, or setting the flipping response time of the liquid crystal in each and every pixel unit of the LCD to be less than a second threshold, the duration of the effective data refreshing time of a display frame could be reduced and a serious dynamic blur caused by liquid crystal flipping could be avoided. When the duration of the effective data refreshing time of the ith display frame is reduced, the blanking time of the ith display frame is increased correspondingly. To ensure the display data of the present display frame could keep displaying during the blanking time of the ith display frame, a way of increasing the capacitance value of the storage capacitance may be used.

In some embodiments, the capacitance value of the storage capacitance of each and every pixel unit of the LCD is greater than a third threshold.

The storage capacitance of each and every pixel unit in the LCD is used to provide a power supply for keeping displaying the display data of the present display frame when the display data of the ith display frame is in the blanking time.

It should be noted that the storage capacitance of each and every pixel unit in the LCD is located between the liquid crystal layer 140 and the array substrate 130 of the LCD panel shown in FIG. 1 (not shown in the figure).

In some embodiments, when the duration of the effective data refreshing time of the ith display frame is shorter than a predetermined duration, the duration of the blanking time of the ith display frame is longer than a predetermined duration. Thus, to ensure the display data of the ith present display frame could keep displaying during the blanking time, the capacitance value of the storage capacitance of each and every pixel unit needs to be greater than a third threshold, so as to obtain a better keeping effect.

The followings are apparatus embodiments of the present disclosure and may be used to perform the method embodiments of the present disclosure. For those details undisclosed in the apparatus embodiments of the present disclosure, reference may be made to the method embodiments of the present disclosure.

FIG. 9 is a block diagram showing an apparatus for controlling a LCD according to an example embodiment, as shown in FIG. 9, the apparatus for controlling a LCD includes, but is not limited to, a first control module 920, and a second control module 940.

The first control module 920, is configured to control a backlight circuit of the LCD to be in an unconnected state during effective data refreshing time of an ith display frame, in which the effective data refreshing time is a time period during which the ith display frame is scanned line by line, in which i represents a positive integer.

The second control module 940, is configured to control the backlight circuit to be in a connected state during blanking time of the ith display frame, in which the blanking time is a time period during which a current display frame is displayed constantly.

In summary, with the apparatus for controlling a LCD provided in the embodiments of the present disclosure, by controlling the backlight circuit of the LCD to be in an unconnected state during the effective data refreshing time of the ith display frame, in which the effective data refreshing time is the time period during which the ith display frame is scanned line by line, in which i represents a positive integer, and by controlling the backlight circuit of the LCD to be in a connected state during the blanking time of the ith display frame. Thus, the liquid crystal flipping during a refreshment process and the serious dynamic blur caused by this kind of flipping may be avoided. During the effective data refreshing time, the backlight circuit is controlled to be in an unconnected state, i.e. the backlight is not illumined, thus making the flipping process of the liquid crystal invisible, a serious dynamic blur caused by liquid crystal flipping is avoided and the display performance of an LCD is optimized.

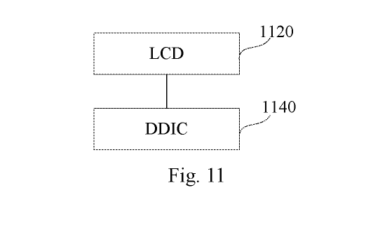

FIG. 10 is a block diagram showing an apparatus for controlling a LCD according to another example embodiment, as shown in FIG. 10, the apparatus for controlling the LCD includes, but not limited to, a data refreshing module 1020, a first control module 1040, and a second control module 1060.

The data refreshing module 1020, is configured to refresh the display data of the ith display frame into the LCD during the effective data refreshing time of the ith display frame, in which a duration of the effective data refreshing time is shorter than a predetermined duration.

In some embodiments, the data refreshing module 1020 includes a data acquiring sub-module 1021 and a data refreshing sub-module 1022.

The data acquiring sub-module 1021 is configured to acquire the display data of the ith display frame from a CPU, in which an acquisition time of the display data is less than a first threshold.

In some embodiments, a flipping response time of liquid crystal in each and every pixel unit of the LCD is less than a second threshold, and/or a capacitance value of a storage capacitance of each and every pixel unit of the LCD is greater than a third threshold.

The data refreshing sub-module 1022 is configured to refresh display data of the the ith display frame line by line into each line of pixel units of the LCD in an order from top to bottom and left to right.

A first control module 1040, is configured to control the backlight circuit of the LCD to be in an unconnected state during the effective data refreshing time of the ith display frame, the effective data refreshing time is the time period during which the ith display frame is scanned line by line, in which i represents a positive integer.

In some embodiments, the first control module 1040 is configured to provide a pause-width modulation signal to the backlight circuit of the LCD, a wave pattern of the pause-width modulation signal corresponding to the effective data refreshing time of the ith display frame is a first level signal, and the first level signal is used for controlling the backlight circuit of the LCD to be in an unconnected state.

A second control module 1060, is configured to control the backlight circuit to be in a connected state during the blanking time of the ith display frame, the blanking time is the time period during which the current display frame is displayed constantly.

In some embodiments, a wave pattern of the pause-width modulation signal corresponding to the blanking time of the ith display frame is a second level signal, and the second level signal is used for controlling the backlight circuit of the LCD to be in a connected state. The level value corresponding to the first level signal is lower than a level value corresponding to the second level signal.

In summary, with the apparatus for controlling a LCD provided in the embodiments of the present disclosure, by controlling the backlight circuit of the LCD to be in an unconnected state during the effective data refreshing time of the ith display frame, in which the effective data refreshing time is the time period during which the ith display frame is scanned line by line, in which i represents a positive integer, and by controlling the backlight circuit of the LCD to be in a connected state during the blanking time of the ith display frame. Thus, the liquid crystal flipping during a refreshment process and the serious dynamic blur caused by this kind of flipping may be avoided. During the effective data refreshing time, the backlight circuit is controlled to be in an unconnected state, i.e. the backlight is not illumined, thus making the flipping process of the liquid crystal invisible, a serious dynamic blur caused by liquid crystal flipping is avoided and the display performance of an LCD is optimized.

In addition, with the effective data refreshing time less than a predetermined duration, the transmitting time less than a first threshold and the flipping response time of the liquid crystal in each and every pixel unit of the LCD less than a second threshold, the duration of the effective data refreshing time of a display frame could be reduced and a serious dynamic blur caused by liquid crystal flipping could be avoided, the display performance of an LCD is optimized.

With regard to the device of the above embodiment, the specific operation manners for individual modules therein refer to those described in detail in the embodiments regarding the methods, which are not elaborated herein again.

FIG. 11 is a block diagram showing an electronic device according to an example embodiment. The electronic device is configured to perform the method for controlling a LCD of the present disclosure, the electronic device includes an LCD 1120 and a DDIC 1140.

The DDIC 1140 is configured to: control a backlight circuit of the LCD 1120 to be in an unconnected state during effective data refreshing time of an ith display frame, in which the effective data refreshing time is a time period during which the ith display frame is scanned line by line, and in which i represents a positive integer; and control the backlight circuit to be in a connected state during blanking time of the ith display frame, in which the blanking time is a time period during which a current display frame is displayed constantly.

In some embodiments, a duration of the effective data refreshing time of the ith display frame is shorter than a predetermined duration.

In some embodiments, a flipping response time of liquid crystal in each and every pixel unit of the LCD 1120 is less than a second threshold, and/or a capacitance value of a storage capacitance of each and every pixel unit of the LCD 1120 is greater than a third threshold.

In summary, with the electronic device provided in the embodiments of the present disclosure, by controlling the backlight circuit of the LCD to be in an unconnected state during the effective data refreshing time of the ith display frame, in which the effective data refreshing time is the time period during which the ith display frame is scanned line by line, in which i represents a positive integer, and by controlling the backlight circuit of the LCD to be in a connected state during the blanking time of the ith display frame. Thus, the liquid crystal flipping during a refreshment process and the serious dynamic blur caused by this kind of flipping may be avoided. During the effective data refreshing time, the backlight circuit is controlled to be in an unconnected state, i.e. the backlight is not illumined, thus making the flipping process of the liquid crystal invisible, a serious dynamic blur caused by liquid crystal flipping is avoided and the display performance of an LCD is optimized.

Other embodiments will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for controlling a liquid crystal display (LCD), the method comprising:
controlling a backlight circuit of the LCD to be in an unconnected state during effective data refreshing time of an ith display frame, wherein the effective data refreshing time is a time period during which the ith display frame is scanned line by line, and wherein i represents a positive integer; and
controlling the backlight circuit to be in a connected state during blanking time of the ith display frame, wherein the blanking time is a time period during which a current display frame is displayed constantly.

2. The method according to claim 1, wherein controlling a backlight circuit of the LCD to be in an unconnected state during effective data refreshing time of an ith display frame comprises:
providing a pause-width modulation signal to the backlight circuit of the LCD, wherein a wave pattern of the pause-width modulation signal corresponding to the effective data refreshing time of the ith display frame is a first level signal for controlling the backlight circuit to be in the unconnected state.

3. The method according to claim 2, wherein a wave pattern of the pause-width modulation signal corresponding to the blanking time of the ith display frame is a second level signal for controlling the backlight circuit of the LCD to be in the connected state; and
wherein a level value corresponding to the first level signal is lower than a level value corresponding to the second level signal.

4. The method according to claim 1, wherein the method further comprises:
refreshing display data of the ith display frame into the LCD during the effective data refreshing time of the ith display frame, wherein a duration of the effective data refreshing time is shorter than a predetermined duration.

5. The method according to claim 4, wherein refreshing display data of the ith display frame into the LCD comprises:
acquiring the display data of the ith display frame from a central processing unit (CPU), wherein an acquisition time of the display data is less than a first threshold; and
refreshing the display data of the ith display frame line by line into each line of pixel units of the LCD in an order from top to bottom and left to right.

6. The method according to claim 5, wherein acquiring the display data of the ith display frame from a CPU comprises:
acquiring the display data of the ith display frame from the CPU during the effective data refreshing time of the ith display frame, so as to refresh the display data of the ith display frame.

7. The method according to claim 5, wherein acquiring the display data of the ith display frame from a CPU comprises:
acquiring the display data of the ith display frame from the CPU during the blanking time of the ith display frame, so as to refresh the display data of the ith display frame when entering the effective data refreshing time of the ith display frame.

8. The method according to claim 5, wherein a flipping response time of liquid crystal in each pixel unit of the LCD is less than a second threshold; and/or
wherein a capacitance value of a storage capacitance of each pixel unit of the LCD is greater than a third threshold.

9. An apparatus for controlling a LCD, the apparatus comprising:
a processor;
a memory, configured to store instructions executable by the processor;
in which the processor is configured to:
control a backlight circuit of the LCD to be in an unconnected state during effective data refreshing time of an ith display frame, wherein the effective data refreshing time is a time period during which the ith display frame is scanned line by line, and wherein i represents a positive integer; and
control the backlight circuit to be in a connected state during blanking time of the ith display frame, wherein the blanking time is a time period during which a current display frame is displayed constantly.

10. The apparatus according to claim 9, wherein the processor configured to control a backlight circuit of the LCD to be in an unconnected state during effective data refreshing time of an ith display frame is further configured to:
provide a pause-width modulation signal to said backlight circuit of the LCD, wherein a wave pattern of the pause-width modulation signal corresponding to the effective data refreshing time of the ith display frame is a first level signal for controlling the backlight circuit to be in the unconnected state.

11. The apparatus according to claim 10, wherein a wave pattern of the pause-width modulation signal corresponding to the blanking time of the ith display frame is a second level signal for controlling the backlight circuit of the LCD to be in the connected state, and
wherein a level value corresponding to the first level signal is lower than a level value corresponding to the second level signal.

12. The apparatus according to claim 9, wherein the processor is further configured to:
refresh display data of the ith display frame into the LCD during the effective data refreshing time of the ith display frame, wherein a duration of the effective data refreshing time is shorter than a predetermined duration.

13. The apparatus according to claim 12, wherein the processor configured to refresh display data of the ith display frame into the LCD is further configured to:
acquire the display data of the ith display frame from a CPU, wherein an acquisition time of the display data is less than a first threshold; and
refresh the display data of the ith display frame line by line into each line of pixel units of the LCD in an order from top to bottom and left to right.

14. The apparatus according to claim 13, wherein a flipping response time of liquid crystal in each pixel unit of the LCD is less than a second threshold; and/or
wherein a capacitance value of a storage capacitance of each pixel unit of the LCD is greater than a third threshold.

15. An electrical device, comprising:
a LCD; and
a display driver integrated circuit (DDIC) configured to:
control a backlight circuit of the LCD to be in an unconnected state during effective data refreshing time of an ith display frame, wherein the effective data refreshing time is a time period during which the ith display frame is scanned line by line, and wherein i represents a positive integer; and
control the backlight circuit to be in a connected state during blanking time of the ith display frame; wherein the blanking time is a time period during which a current display frame is displayed constantly.

16. The electrical device according to claim 15, wherein the DDIC configured to control a backlight circuit of the LCD to be in an unconnected state during effective data refreshing time of an ith display frame is further configured to:
provide a pause-width modulation signal to the backlight circuit of the LCD, wherein a wave pattern of the pause-width modulation signal corresponding to the effective data refreshing time of the ith display frame is a first level signal for controlling the backlight circuit to be in the unconnected state.

17. The electrical device according to claim 16, wherein a wave pattern of the pause-width modulation signal corresponding to the blanking time of the ith display frame is a second level signal for controlling the backlight circuit of the LCD to be in the connected state; and
wherein a level value corresponding to the first level signal is lower than a level value corresponding to the second level signal.

18. The electrical device according to claim 15, wherein the DDIC is further configured to:
refresh display data of the ith display frame into the LCD during the effective data refreshing time of the ith display frame, wherein a duration of the effective data refreshing time is shorter than a predetermined duration.

19. The electrical device according to claim 18, wherein the DDIC configured to refresh display data of the ith display frame into the LCD is further configured to:
acquire the display data of the ith display frame from a CPU, wherein an acquisition time of the display data is less than a first threshold; and
refresh the display data of the ith display frame line by line into each line of pixel units of the LCD in an order from top to bottom and left to right.

20. The electronic device according to claim 15, wherein a flipping response time of liquid crystal in each pixel unit of the LCD is less than a second threshold; and/or
wherein a capacitance value of a storage capacitance of each pixel unit of the LCD is greater than a third threshold.
